(19) United States
(12) Patent Application Publication
(10) Pub. No.: US 2014/0174624 A1
(43) Pub. Date: Jun. 26, 2014

(54) Variable Belt Configuration

(71) Applicant: BRIDGESTONE AMERICAS TIRE OPERATIONS, LLC, (US)

(72) Inventors: Justin E. Hayes, Mount Juliet, TN (US); David A. Johnson, Mount Juliet, TN (US)

(73) Assignee: BRIDGESTONE AMERICAS TIRE OPERATIONS, LLC, Nashville, TN (US)

(21) Appl. No.: 13/723,231

(22) Filed: Dec. 21, 2012

(51) Int. Cl. B60C 9/18

(52) U.S. Cl. CPC B60C 9/18
USPC 152/527; 152/535

(57) ABSTRACT

A pneumatic tire has a belt layer disposed between a carcass ply and a circumferential tread, defining a crown region. The belt layer includes a first section and a second section laterally spanning the crown region. The first section includes a plurality of first reinforcing members constructed of a plurality of first filaments composed of a first material. The second section includes a plurality of second reinforcing members constructed of a plurality of second filaments composed of a second material. The first section is characterized by a first fabric density and a first crown angle. The second section is characterized by a second fabric density and a second crown angle. At least one of the first crown angle, the first material, the first number of first filaments, and the first fabric density is different from the respective second crown angle, second material, second number of filaments, and second fabric density.

### FIELD OF INVENTION

This disclosure relates to an alternative belt configuration in a tire. Specifically, this disclosure relates to belt tire configurations where different portions of a belt ply have different characteristics.

### BACKGROUND

Known pneumatic tires include a belt layer disposed between a carcass ply and a circumferential tread. The belt layer or belt package of a design includes one or more belt plies, each having consistently spaced reinforcing members disposed at a crown angle with respect to an equatorial plane of the tire. Classically, the crown angle in one belt ply is equal and opposite to the crown angle of another belt ply. However, the crown angle within a single belt ply does not change. Additionally, known tires include a uniform filament type and fabric density across the entire span of each belt ply in the tire. Known belt plies also have a uniform number of filaments per reinforcing member in a single ply. These parameters (i.e., crown angle, filament type, fabric density, and number of filaments per reinforcing member) can all influence tire performance.

### SUMMARY

In one embodiment, a pneumatic tire includes a carcass ply, a circumferential tread, and a belt layer disposed between the carcass ply and the circumferential tread, which together define the crown region of the tire. The belt layer includes at least one variable annular belt having at least two sections. The first section is beside the second section, such that the first and second sections together span laterally along the crown region of the tire. The first section includes a plurality of first reinforcing members constructed of a plurality of first filaments coated by a first polymeric skim. The first section is characterized by the plurality of first reinforcing members having a first crown angle. In the first section, the plurality of first filaments are composed of a first material. Additionally, the first section has a first number of first filaments disposed in each first reinforcing member. The first section is also characterized by a first section fabric density. The second section of the pneumatic tire includes a plurality of second reinforcing members constructed of the plurality of second filaments coated by a second polymeric skim. The second section is characterized by the plurality of second reinforcing members having a second crown angle different from the first crown angle. Additionally, the second section has a plurality of second filaments composed of a second material different from the first material. In the second section a second number of second filaments are disposed in each second reinforcing member that is different from the first number. The second section has a fabric density that is different from the first fabric density.

In another embodiment a pneumatic tire has a carcass ply, a circumferential tread, and a belt layer disposed between the carcass ply and the circumferential tread, which together define a crown region of the tire. The belt layer includes at least one variable annular belt having a shoulder region and a center region spanning laterally along the crown region of the tire. The shoulder region includes a plurality of shoulder region cord bundles. Additionally, the center region includes a plurality of center region cord bundles having a different stiffness than the plurality of shoulder region cord bundles.

In yet another embodiment, a tire has a carcass ply, a circumferential tread, and a belt layer disposed between the carcass ply and the circumferential tread, which together define a crown region of the tire. The belt layer includes at least one variable annular belt having at least two sections including a first section beside a second section, such that the first and second sections together span laterally along the crown region of the tire. The first section of the annular belt includes a plurality of first reinforcing members coated by a polymeric material where the first reinforcing members are constructed of a plurality of first filaments that are composed of a first material. The first section of the annular belt is characterized by a first fabric density and a first crown angle. The second section of the annular belt includes a plurality of second reinforcing members coated by the polymeric material where the second reinforcing members are constructed of a plurality of second filaments composed of a second material. Additionally, the second section of the annular belt is characterized by a second fabric density and a second crown angle. At least one of the first crown angle, the first material, the first number of first filaments, and the first fabric density is different from the respective second crown angle, second material, second number of filaments, and second fabric density.

### BRIEF DESCRIPTION OF THE DRAWINGS

FIG. 1 is a sectional view of a portion of a tire 100.

FIG. 2 is a partial perspective view of a crown portion of the tire 100 having some parts removed for clarity.

FIG. 3 is a partial perspective view of a belt ply of the tire 100.

FIG. 4 is a partial perspective view of a crown portion of an alternative embodiment of a tire 300 having some parts removed for clarity.

FIG. 5 is a partial perspective view of a belt ply of the tire 300.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Tread” refers to that portion of the tire that comes into contact with the road under normal inflation and load.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

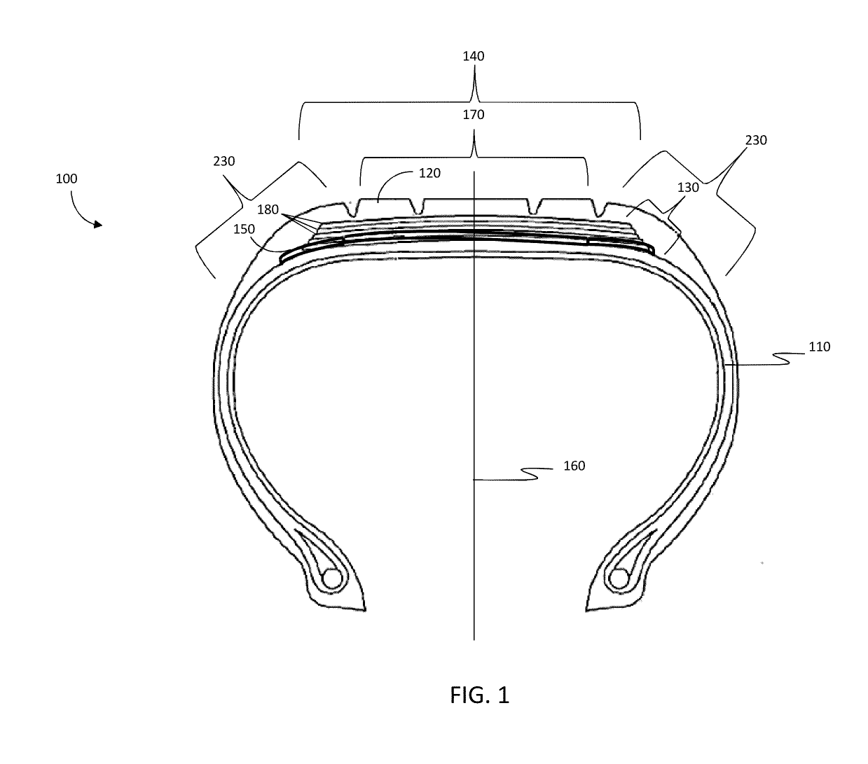

FIG. 1 illustrates a pneumatic tire 100 with a carcass ply 110, a circumferential tread 120, and a belt layer 130 disposed between the carcass ply 110 and the circumferential tread 120, which together define the crown region 140 of the pneumatic tire 100. The pneumatic tire 100 has a shoulder area 230 in the outer portion of the tire 100 and a center region 170 in the inner portion of the tire 100. In the illustrated embodiment, the belt layer 130 includes multiple annular belt plies 180. The annular belts 180 have reinforcing members disposed at an angle with respect to the equatorial plane 160. In the illustrated embodiment, the lower annular belt ply is a variable annular belt 150. In an alternative embodiment (not shown), the tire has a single annular belt. In yet another embodiment, any of the annular belt plies 180 may be a variable annular belt 150 as described in further detail below.

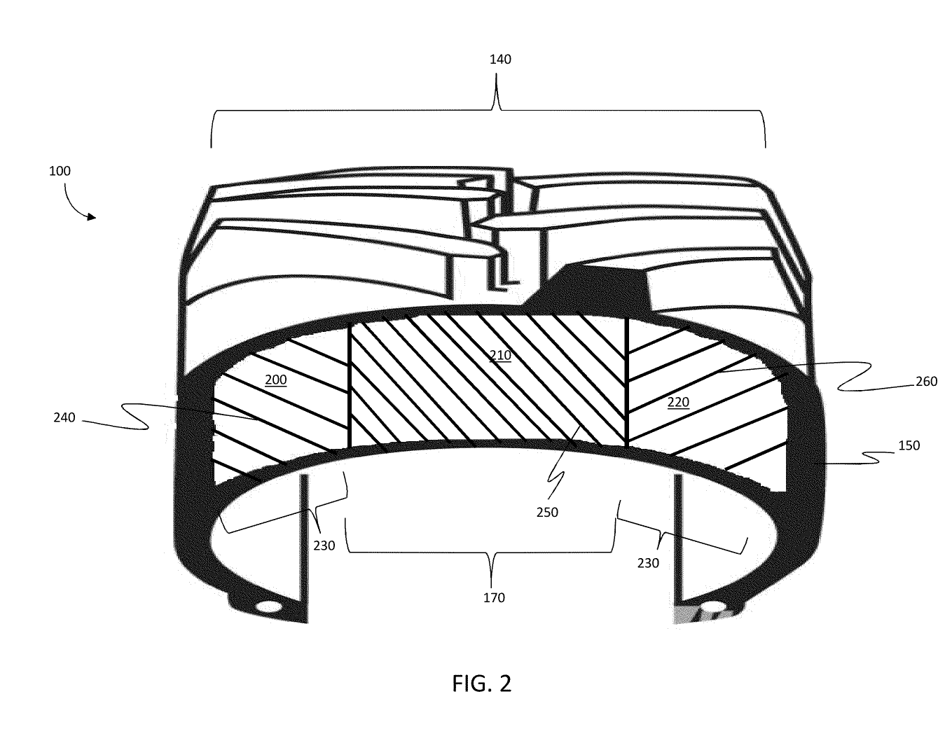

FIG. 2 illustrates a partial perspective view of the crown portion 140 of the tire 100 having some parts removed for clarity. In the illustrated embodiment, the variable annular belt 150 has three sections 200, 210, 220. A first section 200 is located in a shoulder area 230 of the pneumatic tire 100. The first section 200 has a plurality of first reinforcing members 240. The first section 200 is adjacent to a second section 210. The second section 210 is located in the center region 170 of the pneumatic tire 100. Additionally, the second section 210 has a plurality of second reinforcing members 250. The second section 210 is adjacent to a third section 220. The third section 220 is located in a shoulder area 230 opposite the first section 200. The third section has a plurality of third reinforcing members 260. All three sections span laterally along the crown region 140 of the pneumatic tire 100.

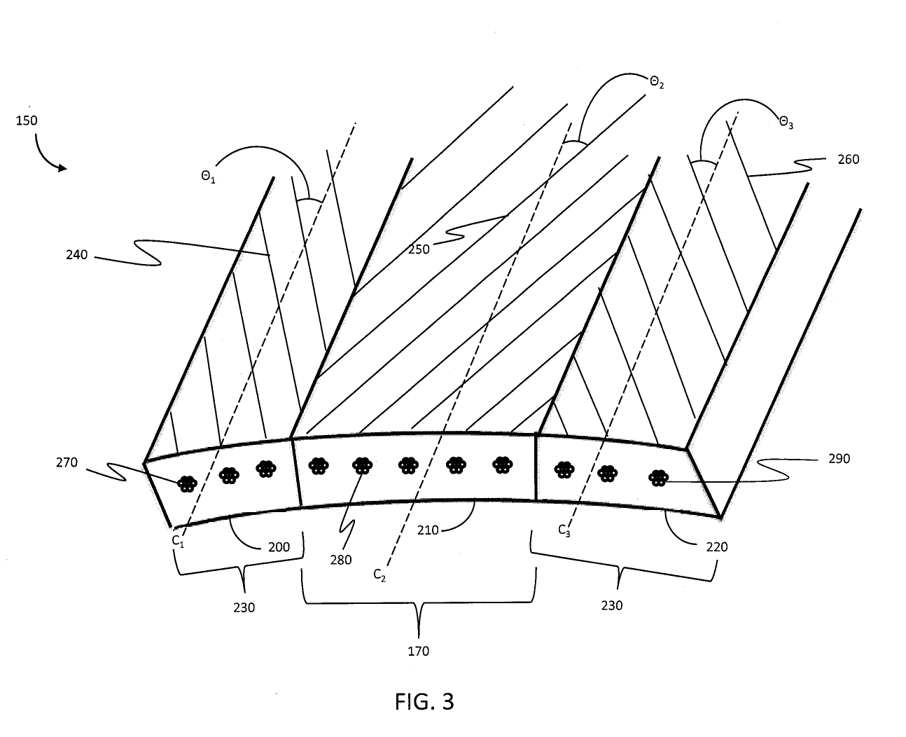

FIG. 3 is a partial perspective view showing greater detail of the variable annular belt 150. The belt layer 130 includes a first section 200 having a plurality of first reinforcing members 240 constructed of a plurality of first filaments 270. A first polymeric skim is extruded or calendered onto the first section to form a coating on the first reinforcing members 240. The second section 210 includes a plurality of second reinforcing members 250 constructed of a plurality of second filaments 280. A second polymeric skim is extruded or calendered onto the second section to form a coating on the second reinforcing members 250. The third section 220 includes a plurality of third reinforcing members 260 constructed of a plurality of third filaments 290. A third polymeric skim is extruded or calendered onto the third section 220 to form a coating on the third filaments 290. In each section, the reinforcing members are carbon steel wire coated with brass that has been drawn, plated, twisted and wound into multiple-filament bundles. In an alternative embodiment the reinforcing members may be polyester, nylon, rayon, any synthetic fiber, metallic cables, cords, brass plated steel cords, carbon fiber, any other suitable metal, or any other suitable material. It should be understood that in alternative embodiments with four or more sections, these additional sections may include a plurality of additional reinforcing members constructed of a plurality of additional filaments and additional polymeric skims.

The first, second and third sections 200, 210, 220 are characterized by a first, second and third skim gauge. The skim gauge is the thickness of the skim coating between two neighboring belt plies. In one embodiment, a single skim is extruded across the span of each section of the variable belt 150 such that the first, second and third skim gauges are substantially the same. In an alternative embodiment, the skim gauge between an upper belt ply and a neighboring belt ply below it may be different from any other skim gauge in the belt layer 130, i.e., a skim gauge between two other belt plies.

As shown in FIG. 3, the first section 200 is characterized by the plurality of first reinforcing members 240 having a first crown angle Θ₁, as measured relative to a line C₁ which extends in a direction parallel to the equatorial plane (mid-circumferential plan) 160 and is tangent to the first section 200 of the variable annular belt 150. The second section 210 is characterized by the plurality of second reinforcing members 250 having a second crown angle Θ₂ as measured relative to a line C₂ which extends in a direction parallel to the equatorial plane 160 and is tangent to the second section 210 of the variable annular belt 150. The third section 220 is characterized by a plurality of third reinforcing members 260 having a third crown angle Θ₃ as measured relative to a line C₃ which extends in a direction parallel to the equatorial plane and is tangent to the third section 220 of the variable annular belt 150. Additional sections may be characterized by a plurality of additional reinforcing members having additional crown angles. The first and third crown angles Θ₁, Θ₃ may be different from the second crown angle Θ₂. Additionally, any of the crown angles may be substantially the same or different from any other crown angle in a different section.

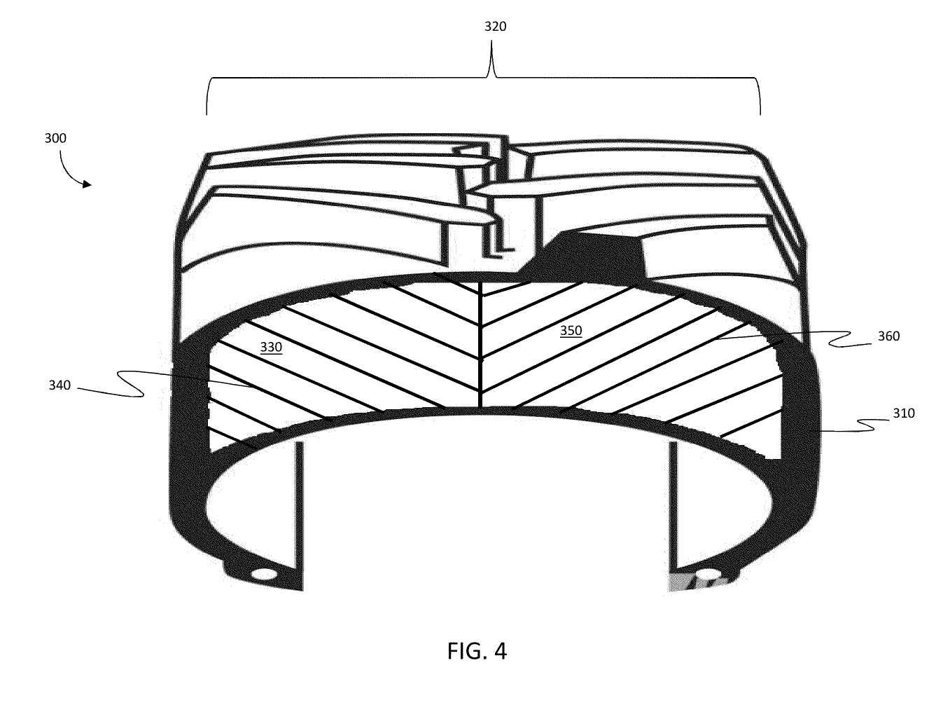

FIG. 4 illustrates an alternative embodiment of a tire 300 having a variable annular belt 310 with two sections. The illustrated embodiment is a partial perspective view of the crown portion 320 of the tire 300 having some parts removed for clarity. A first section 330 of the belt 310 has a plurality of first reinforcing members 340. The first section 330 is adjacent to a second section 350. The second section 350 has a plurality of second reinforcing members 360. Both sections span laterally along the crown region 320 of the pneumatic tire 300. In another alternative embodiment (not shown), the variable annular belt has four or more sections.

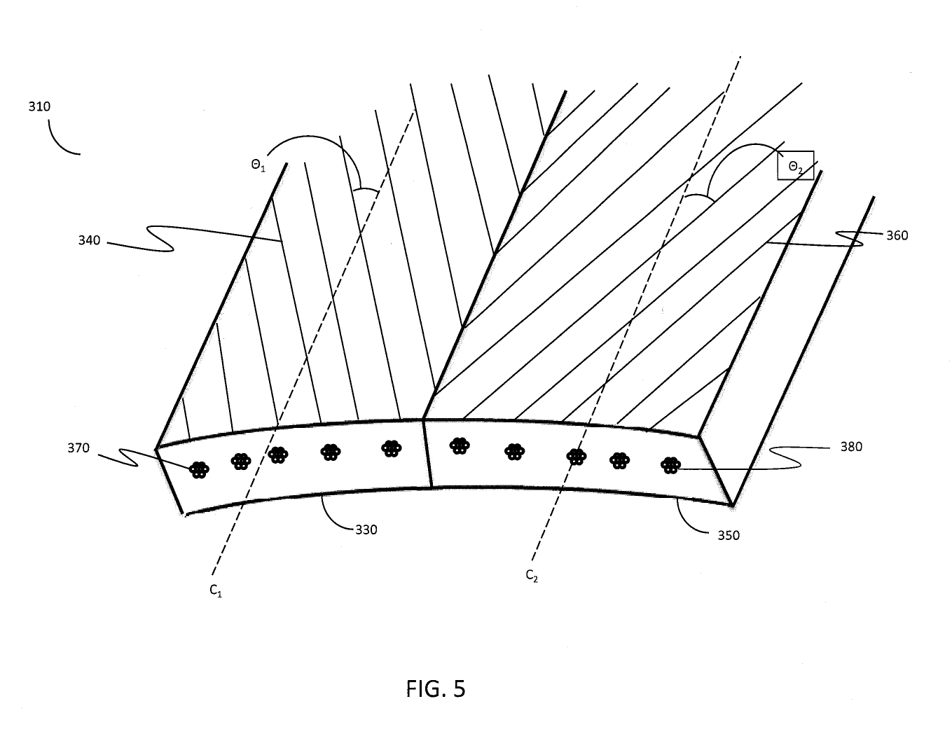

FIG. 5 is a partial perspective view showing greater detail of the variable annular belt 310. The belt includes the first section 330 having a plurality of first reinforcing members 340 constructed of a plurality of first filaments 370. A first polymeric skim is extruded or calendered onto the first section to form a coating on the first reinforcing members 340. The second section 350 includes a plurality of second reinforcing members 360 constructed of a plurality of second filaments 380. A second polymeric skim is extruded or calendered onto the second section to form a coating on the second reinforcing members 360. In each section, the reinforcing members are carbon steel wire coated with brass that has been drawn, plated, twisted and wound into multiple-filament bundles. In an alternative embodiment the reinforcing members may be polyester, nylon, rayon, any synthetic fiber, metallic cables, cords, brass plated steel cords, carbon fiber, any other suitable metal, or any other suitable material.

The first and second sections 330, 350 are characterized by a first and second skim gauge. In one embodiment, a single skim is extruded across the span of each section of the variable belt 310 such that the first and second skim gauges are substantially the same.

As shown in FIG. 5, the first section 330 is characterized by the plurality of first reinforcing members 340 having a first crown angle Θ₁, as measured relative to a line C₁ which extends in a direction parallel to the equatorial plane (mid-circumferential plan) and is tangent to the first section 330 of the variable annular belt 310. The second section 350 is characterized by the plurality of second reinforcing members 360 having a second crown angle Θ₂ as measured relative to a line C₂ which extends in a direction parallel to the equatorial plane and is tangent to the second section 350 of the variable annular belt 310. The first and second crown angles Θ₁, Θ₂ may be different from one another. The first and second crown angles Θ₁, Θ₂ may be oriented in opposite directions from one another. Alternatively, the first and second crown angles Θ₁, Θ₂ may be may be substantially the same as one another.

In the first section 200 the plurality of first filaments 270 are composed of a first material. Additionally, the second section 210 has a plurality of second filaments 280 composed of a second material. In one embodiment, the second material may be different from the first material. The third section 220 has a plurality of third filaments 290 composed of a third material. In another embodiment, the third material may be different from the first and second material. Likewise, additional sections may have a plurality of additional filaments composed of an additional material different from the any other material. Examples of material that compose the filaments above include polyester, rayon, nylon, any synthetic fiber, steel, aluminum, copper, metal alloys, carbon fiber, any other suitable metal, or any other suitable material. In alternative embodiments, one or more of the first, second, and third materials may be the same.

Additionally, each first reinforcing member 240 in the first section 200 is constructed of a first number of first filaments 270. Each second reinforcing member 250 in the second section 210 is constructed of a second number of second filaments 280. In one embodiment, the second number of second filaments 280 is different from the first number. Each third reinforcing member 260 in the third section 220 has a third number of third filaments 290. In another embodiment, the third number of third filaments 290 is different from the first number and second number. Additional sections may have an additional number of additional filaments disposed in each additional reinforcing member. In alternative embodiments, one or more of the first, second, and third number of filaments may be the same.

The filaments in each section form cord bundles. Each cord bundle in the shoulder region 230 has a first diameter. Each cord bundle in the center region 170 has a second diameter that is substantially the same as the first diameter. In alternative embodiments, the first diameter may be different than the second diameter.

The first section 200 is also has a first fabric density. Fabric density is the number of reinforcing members per inch taken in a specific direction. Density is measured in a direction perpendicular to the direction of the reinforcing members. The second section 210 has a second fabric density different from the first fabric density. The third section 220 has a third fabric density different from the first fabric density and the second fabric density. Additional sections may have additional different fabric densities. In alternative embodiments, one or more of the first, second, and third fabric densities may be the same.

In one embodiment, the second filaments 280 have a different stiffness than the first and third filaments 270, 290. Alternatively, stiffness of the second filaments 280 may be substantially the same as the stiffness of the first and third filaments 270, 290. In yet another embodiment. the first filaments 270 may have a different stiffness that the third filaments 290. The stiffness of a section of the belt is measured as a strength per unit width in a direction parallel to the equatorial plane 160.

In the embodiments illustrated in FIGS. 2-5, the direction of reinforcing members in one section is opposite the direction of the reinforcing members in another section relative to the equatorial plain. As illustrated in FIGS. 4 and 5, the reinforcing members in the first section 330 and the second section 350 extend in the opposite direction relative to the equatorial plane 160 of the pneumatic tire 100. As illustrated in FIGS. 2 and 3, the reinforcing members in the first section 200 and the third section 220 extend in the same direction relative to the equatorial plane 160 of the pneumatic tire 100. The direction the reinforcing members in the second section 210 extend in an opposite direction compared to the reinforcing members in the first and third sections 200, 220. In an alternative embodiment, the direction of reinforcing members in each section are the same as any other section.

The belt layer 130 as illustrated in FIG. 1 includes multiple conventional belt plies 180 in addition to the variable annular belt 150. In an alternative embodiment, some or all of the belt plies in the belt layer 130 may have at least two sections adjacent to another section spanning laterally along the crown region 140 of the pneumatic tire 100. A first section may be located in the shoulder area of the tire and a second section may be located in the center region of the tire and be adjacent to the first section. The reinforcing members in a section may have a crown angle that is different or substantially the same as the crown angle of reinforcing members in the section adjacent to it. Each belt ply 180 in the belt layer 130 may have the same number of sections or a different number of sections as the belt ply located on top or bottom of that belt ply.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A pneumatic tire comprising:
a carcass ply;
a circumferential tread; and
a belt layer disposed between the carcass ply and the circumferential tread, thereby defining a crown region of the tire,
wherein the belt layer includes at least one variable annular belt having at least two sections including a first section beside a second section, such that the first and second sections together span laterally along the crown region of the tire;
wherein the first section includes a plurality of first reinforcing members constructed of a plurality of first filaments coated by a first polymeric skim,
wherein the first section is characterized by
the plurality of first reinforcing members having a first crown angle;
the plurality of first filaments being composed of a first material;
a first number of first filaments disposed in each first reinforcing member;
a first section fabric density; and
wherein the second section includes a plurality of second reinforcing members constructed of a plurality of second filaments coated by a second polymeric skim,
wherein the second section is characterized by
the plurality of second reinforcing members having a second crown angle different from the first crown angle;
the plurality of second filaments being composed of a second material different from the first material;
a second number of second filaments disposed in each second reinforcing member different from the first number; and
a second section fabric density different from the first fabric density.

2. The pneumatic tire of claim 1, wherein the first polymeric skim is constructed of a different chemical composition than the second polymeric skim.

3. The pneumatic tire of claim 1, further comprising a third section beside the second section, such that the first, second and third sections together span laterally along the crown region of the tire,
wherein the third section includes of a plurality of third reinforcing members composed of the plurality of third filaments coated by a third polymeric skim;
wherein the third section is characterized by
the plurality of third reinforcing members having a third crown angle;
the plurality of third filaments composed of a third material;
a third number of third filaments in each third reinforcing member;
a third section fabric density; and
wherein the third crown angle is different than the second crown angle.

4. The pneumatic tire of claim 3, wherein the third material is different than the second material.

5. The pneumatic tire of claim 3, wherein the third number of third filaments in each third reinforcing member is different than the second number of second filaments in each second reinforcing member.

6. The pneumatic tire of claim 3, wherein the third section fabric density is different than the second section fabric density.

7. A pneumatic tire comprising:
a carcass ply;
a circumferential tread;
a belt layer disposed between the carcass ply and the circumferential tread, thereby defining a crown region of the tire,
wherein the belt layer includes at least one variable annular belt having a shoulder region and a center region spanning laterally along the crown region of the tire;
wherein the shoulder region includes a plurality of shoulder region cord bundles; and
wherein the center region includes a plurality of center region cord bundles having a different stiffness than the plurality of center region cord bundles.

8. The pneumatic tire of claim 7, wherein
each shoulder region cord bundle has a first diameter and is composed of a first number of shoulder region filaments,
each center region cord bundle has a second diameter and is composed of a second number of center region filaments different than the first number, and
the first diameter is substantially the same as the second diameter.

9. The pneumatic tire of claim 7 wherein the shoulder region bundles are disposed at a first crown angle and the center region bundles are disposed at a second crown angle different from the first crown angle.

10. The pneumatic tire of claim 7 wherein
the shoulder region cord bundles are constructed of shoulder region filaments that are composed of a first material,
the center region cord bundles are constructed of center region filaments that are composed of a second material different from the first material.

11. The pneumatic tire of claim 7 wherein
the shoulder region of the variable annular belt has a first tire fabric density,
the center region of the variable annular belt has a second tire fabric density different from the first tire fabric density.

12. The pneumatic tire of claim 7, wherein the plurality of shoulder region cord bundles have a greater stiffness than the plurality of center region cord bundles.

13. The pneumatic tire of claim 7,
wherein the plurality of shoulder region cord bundles are coated by a shoulder region skim characterized by a shoulder region skim gauge and
wherein the plurality of center region cord bundles are coated by a center region skim characterized by a center region skim gauge that is different from the shoulder region skim gauge.

14. The pneumatic tire of claim 7,
wherein the plurality of shoulder region cord bundles are coated by a shoulder region skim characterized by a shoulder region skim gauge and
wherein the plurality of center region cord bundles are coated by a center region skim characterized by a center region skim gauge that is substantially the same as the shoulder region skim gauge.

15. A tire comprising:
a carcass ply;
a circumferential tread;
a belt layer disposed between the carcass ply and the circumferential tread, thereby defining a crown region of the tire,
wherein the belt layer includes at least one variable annular belt having at least two sections including a first section beside a second section, such that the first and second sections together span laterally along the crown region of the tire,
wherein the first section of the variable annular belt includes a plurality of first reinforcing members coated by a polymeric material where the first reinforcing members are constructed of a plurality of first filaments composed of a first material,
wherein the first section of the variable annular belt is characterized by a first fabric density and a first crown angle,
wherein the second section of the variable annular belt includes a plurality of second reinforcing members coated by the polymeric material where the second reinforcing members are constructed of a plurality of second filaments composed of a second material,
wherein the second section of the variable annular belt is characterized by a second fabric density and a second crown angle, and
wherein at least one of the first crown angle, the first material, the first number of first filaments, and the first fabric density is different from the respective second crown angle, second material, second number of filaments, and second fabric density.

16. The tire of claim 15, further comprising:
a third section beside the second section, such that the first, second, and third sections together span laterally along the crown region of the tire,
wherein the third section of the variable annular belt includes a plurality of third reinforcing members coated by a polymeric material where the third reinforcing members are constructed of a plurality of third filaments composed of a third material,
wherein the third section of the variable annular belt is characterized by a third fabric density and a third crown angle.

17. The tire of claim 16, wherein the third crown angle is different than the second crown angle.

18. The tire of claim 16, wherein the third material is different than the second material.

19. The tire of claim 16, wherein the third number of third filaments is different from the second number of second filaments.

20. The tire of claim 16, wherein the third fabric density is different from the second fabric density.
